(19) United States
(12) Patent Application Publication
(10) Pub. No.: US 2020/0011403 A1
(43) Pub. Date: Jan. 9, 2020

(54) Tensioner with Anodized Friction Surface

(71) Applicant: Gates Corporation, Denver, CO (US)

(72) Inventors: Michael Neu, Alsdorf (DE); Peter Helmut Wilhelm, Linsengericht (DE)

(21) Appl. No.: 16/027,959

(22) Filed: Jul. 5, 2018

(51) Int. Cl. F16H 7/12; F16H 7/08

(52) U.S. Cl. CPC F16H 7/1218; F16H 7/0831; F16H 2007/0893; F16H 2007/0865; F16H 2007/081

(57) ABSTRACT

A tensioner comprising a base having a shaft, an arm pivotally engaged with the shaft, a pulley journalled to the arm, a torsion spring engaged between the arm and the base, a damping element for damping an arm movement, the damping element frictionally engaged with the arm upon a pressing engagement by the torsion spring, the arm having an anodic oxide surface finish, and the damping element frictionally engaging the anodic oxide surface finish.

### FIELD OF THE INVENTION

The invention relates to a tensioner with anodized friction surface, and more particularly, to a tensioner with anodized friction surface comprising an arm or base having an anodic oxide surface finish and a damping element frictionally engaging the anodic oxide surface finish.

### BACKGROUND OF THE INVENTION

Belt tensioners are generally well known devices used in various belt-drive systems. The tensioner applies a constant belt-tensioning force, which compensates for increases in belt length due to wear and other factors. A common type of belt tensioner comprises a base and a pivot structure eccentrically mounted on the base. The pivot structure has a belt-engaging pulley journalled thereto. A torsion spring is connected between the base and pivot arm to bias the pivot arm and thereby impart a load on a belt.

It is known to manufacture tensioners using steel components or die cast aluminum. Since the tensioner can be used in hostile conditions, surface corrosion protection is desirable.

For steel various finishes are known including paint or powder coat. Steel may also be alloyed with various materials to form stainless steel, but this can be prohibitively expensive in most cases.

It is also known that aluminum can be anodized, which is a process of electrochemical deposition of an anodic oxide finish on the surface of die cast aluminum.

While use of anodizing is known for certain automotive components, it is not known in the tensioner industry.

Representative of the art is U.S. Pat. No. 5,643,117 which discloses a hydraulic chain tensioner having a check valve vent. The tensioner includes a housing having a bore with a fluid filled chamber, a hollow piston slidably received within the bore and biased in a protruding direction by a spring, and a check valve assembly which permits fluid to flow from an external source through the valve and into the fluid filled chamber. The vent includes a disc positioned against the inlet from the external source of fluid. The disc has at least one channel formed on the surface of the disc facing the external source. The channel has a first end at the periphery of the disc and a second end at the center point of the disc.

What is needed is a tensioner comprising an arm or base having an anodic oxide surface finish and a damping element frictionally engaging the anodic oxide surface finish. The present invention meets this need.

### SUMMARY OF THE INVENTION

The primary aspect of the invention is to provide a tensioner comprising an arm or base having an anodic oxide surface finish and a damping element frictionally engaging the anodic oxide surface finish.

Other aspects of the invention will be pointed out or made obvious by the following description of the invention and the accompanying drawings.

The invention comprises a tensioner comprising a base having a shaft, an arm pivotally engaged with the shaft, a pulley journalled to the arm, a torsion spring engaged between the arm and the base, a damping element for damping an arm movement, the damping element frictionally engaged with the arm upon a pressing engagement by the torsion spring, the arm having an anodic oxide surface finish, and the damping element frictionally engaging the anodic oxide surface finish.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a side view of the tensioner.

FIG. 2 is a plan view of the tensioner.

FIG. 3 is a cross-sectional view A-A of FIG. 2.

FIG. 4 is a prespective view of a tensioner arm.

FIG. 5 is a cross-sectional detail of FIG. 3.

FIG. 6 is a detail of the damping element.

FIG. 7 is an exploded view.

### DETAILED DESCRIPTION OF THE PREFERRED EMBODIMENT

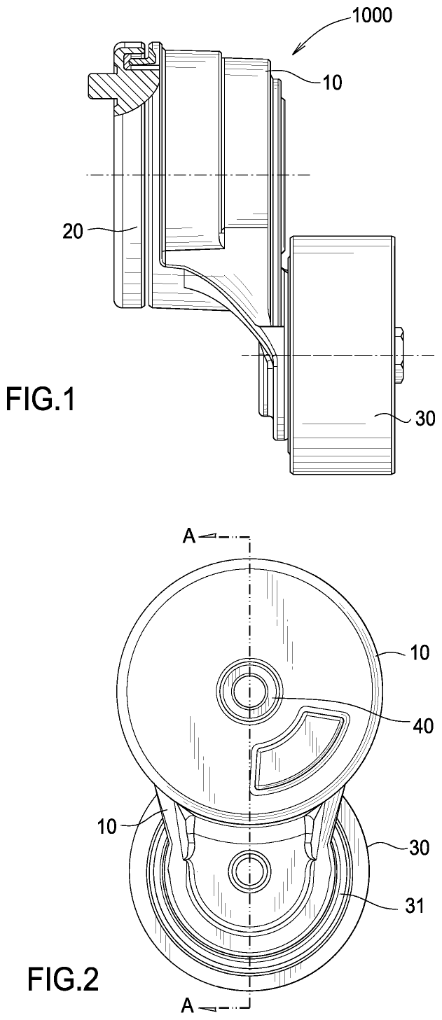

FIG. 1 is a side view of the tensioner. Tensioner 1000 comprises an arm 10 which is pivotally engaged with a shaft 40 projecting from a base 20. Pulley 30 engages a belt (not shown).

FIG. 2 is a plan view of the tensioner. Pulley 30 is journalled to arm 10 on a bearing 31.

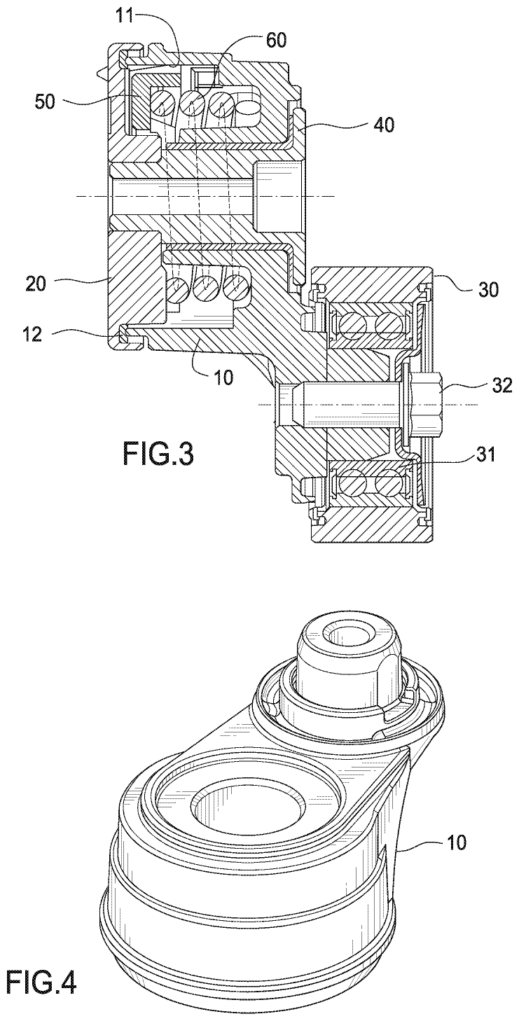

FIG. 3 is a cross-sectional view of FIG. 2 at A-A. Damping element 50 fictionally engages an inner surface 11 of arm 10. Torsion spring 60 is engaged between the arm 10 and base 20. Torsion spring 60 presses upon damping element 50 thereby creating a normal force upon surface 11. The normal force in combination with the coefficient of friction between the damping element and the surface 11 creates a frictional force which damps an oscillatory movement of arm 10 when the tensioner is in operation. The coefficient of friction depends on the surface finish of surface 11 and the material composing damping element 50. Damping element 50 may comprise steel or any plastic material known in the tensioner damping arts.

The inventive tensioner comprises an anodic oxide coating on surface 11 or on all surfaces of the arm or base, or both. The anodic oxide coating significantly reduces wear during operation, which in turn increases the service life of the tensioner.

Anodic oxide formation is an electrochemical corrosion process. It comprises nucleation at separate and distinct preferential sites across the aluminum substrate surface. Preferred sites are those which are not electrochemically complex, that is, sites that are not chemically complex, i.e., sites comprised of aluminum only. Such sites also include those that are not topographically complex, that is, a surface that is continuous with minimal burrs, laps or seams. In short, the preferable substrate is one which favors aluminum oxidation. While such preferred conditions and surfaces are not always available, anodization is still successful for the purposes described herein which include enhanced wear resistance and enhanced corrosion resistance for the tensioner.

As to the casting material used in the arm and base, aluminum with a silicon content between 4% to the eutectic level of 12% tends to reduce scrap losses and yield castings with suitable surface quality. These benefits derive from the effects of silicon and aluminum molten mixtures, which exhibit increased fluidity, reduced cracking and improved feeding to minimize shrinkage porosity. Alloys with the eutectic composition (Al-12%Si) tend to exhibit highest fluidity during casting. However, these ranges are as examples only and are not intended as a limit for the purposes of the instant invention.

Copper, magnesium and zinc are the prevalent secondary alloying elements which impart fluidity during casting and various phases which impart mechanical properties such as strength, corrosion resistance and fatigue resistance. Other alloying elements such as iron, manganese, chromium and titanium can added produce second phase constituents that modify the aluminum-silicon structure and increase strength and hardness.

When compared to comparable parts that have not been hard anodized, the following improvements are shown to be present. The hard anodized tensioner arm and sealing between the arm and the base show a service life time improvement of approximately 25% and lower internal contamination level caused by leak through at the seal.

Physical values of load torque on the arm (specification range of 45 to 75 Nm), unload torque on the arm (specification range of 41 to 24 Nm) and arm/base alignment after 1000 hrs running time are within the acceptable specification limits when compared to failure of like but non-anodized components after only 500 hours of testing. Alignment refers to the axial relationship between the arm and the shaft and which is successfully maintained between 0.00 degrees and 0.20 degrees from 90 degrees to hubload for the anodized components.

Wear at the damping element friction area for the hard anodized tensioner arm compared to the non-anodized tensioner arm is also lower and the life time of the friction surface is extended by about 25%.

FIG. 4 is a prespective view of a tensioner arm. Damping element 50 fictionally engages an inner surface 11 of arm 10. Inner surface 11 extends about the inner circumference of arm 10.

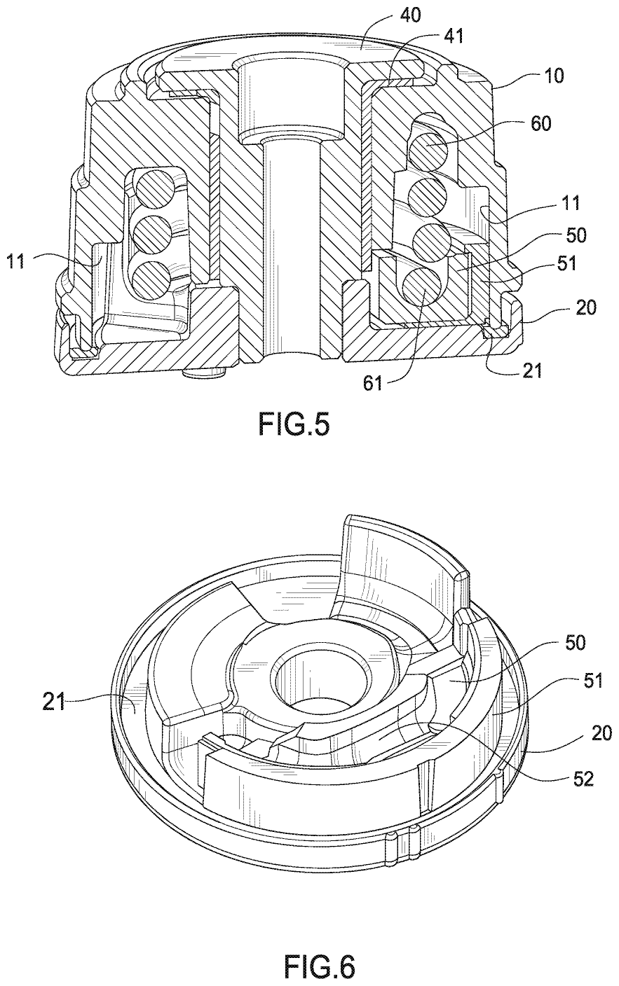

FIG. 5 is a cross-sectional detail of FIG. 3. Seal 21 between the arm 10 and base 20 prevents debris from reaching damping element 50. Shaft 40 is press fit into base 20. Arm 10 pivots about shaft 40 on bushing 41. Surface 11 comprises an anodic oxide (anodized) surface finish. The anodizing is applied to surface 11, and arm 10, in a manner known in the electrochemical anodizing arts as is applied to aluminum die cast materials and components. Anodizing may also be applied to base 20.

This in turn reduces wear between seal 21, base 20 and arm 10.

Damping element 50 comprises friction layer 51 which may comprise steel or any suiable thermoplastic or thermoset plastic material known in the damping arts. Friction layer 51 frictionally engages surface 11, thereby damping movement of arm 10 with respect to base 20.

FIG. 6 is a detail of the damping element. Portion 52 receives end 61 of torsion spring 60. Torsion spring 60 presses damping element 50 radailly outward into a frictional engagement with surface 11.

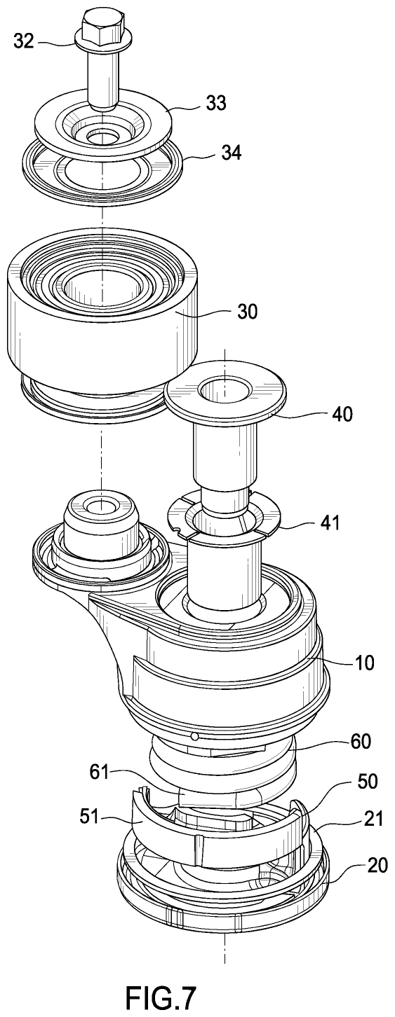

FIG. 7 is an exploded view. Fastener 32 retains pulley 30 on arm 10. Dust shield 33, 34 prevent debris from contaminating bearing 31.

Although a form of the invention has been described herein, it will be obvious to those skilled in the art that variations may be made in the construction and relation of parts and method without departing from the spirit and scope of the invention described herein.

We claim:

1. A tensioner comprising:
a base having a shaft projecting therefrom;
an arm pivotally engaged with the shaft, a pulley journalled to the arm;
a torsion spring engaged between the arm and the base;
a damping element for damping an arm movement, the damping element frictionally engaged with the arm upon a pressing engagement by the torsion spring;
the arm having an anodic oxide finish on an inner surface; and
the damping element frictionally engaging the anodic oxide finish.

2. The tensioner as in claim 1, wherein the arm is die cast aluminum.

3. The tensioner as in claim 1, wherein the base comprises an alloy of aluminum.

4. The tensioner as in claim 1, wherein the base is die cast aluminum.

5. The tensioner as in claim 1 further comprising a seal between the arm and the base.

6. The tensioner as in claim 1, wherein the pulley is journalled on a ball bearing.

7. A tensioner comprising:
a base comprising die cast aluminum;
an arm comprising die cast aluminum pivotally engaged with the base, a pulley journalled to the arm;
a torsion spring engaged between the arm and the base;
a damping element for damping an arm movement, the damping element frictionally engaged with the arm upon a pressing engagement by the torsion spring; and
the arm having an anodic oxide surface finish, the damping element engaging the anodic oxide surface finish.

8. The tensioner as in claim 7, wherein the base comprises an anodic oxide surface finish.

9. A tensioner comprising:
a base comprising die cast aluminum, a shaft projecting from the base;
an arm comprising die cast aluminum pivotally engaged with the shaft, a pulley journalled to the arm;
a torsion spring engaged between the arm and the base;
a damping element for damping an arm movement, the damping element frictionally engaged with the arm upon a pressing engagement by the torsion spring; and
the arm and the base each having an anodic oxide surface finish, the damping element frictionally engaging the anodic oxide surface finish.

10. The tensioner as in claim 9 further comprising a seal between the arm and the base.

11. The tensioner as in claim 9, wherein the pulley is journalled on a ball bearing.
